(19) United States
(12) Patent Application Publication
(10) Pub. No.: US 2005/0094225 A1
(43) Pub. Date: May 5, 2005

(54) Method of operating concatenated contact image-sensing module and apparatus of using the same

(76) Inventor: Darwin Hu, San Jose, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/699,881

(22) Filed: Nov. 4, 2003

(51) Int. Cl. H04N 1/04

(52) U.S. Cl. 358/493; 358/486

(57) ABSTRACT

A method of operating a concatenated contact image-sensing module wherein the concatenated contact image-sensing module includes a plurality of contact image sensors (CIS) is provided. The method includes providing a first contact image sensor for executing a first document reading session through the trigger of a start pulse and then to output a corresponding first scanned image signal, providing a second contact image sensor operatively connected to the first contact image sensor for executing a second document reading session and then to output a corresponding second scanned image signal, and providing a third contact image sensor operatively connected to the second contact image sensor for executing a third document reading session and then to output a corresponding third scanned image signal. These scanned image signals are outputted sequentially and concatenate multiple CIS.

### BACKGROUND OF THE INVENTION

1. Field of the Invention

The present invention relates to a method of operating a concatenated contact image-sensing module and an apparatus of using the same method, and more particularly, to a method of operating a concatenated contact image-sensing module by employing an end pulse generated from any given contact image sensor of the module to trigger a corresponding document reading session of another contact image sensor operatively connected in series with the former contact image sensor, and an apparatus of using the same method. Furthermore, even after receiving all outputted scanned image signal, the present invention alternatively provides an analog switch for selecting one scanned image signal to output one time.

2. Description of the Prior Art

Please refer to FIG. 1, which is a cross section view and a block diagram of a Contact Image Sensor Module (CIS) according to the prior art. Therein, the CIS module includes a light source 30, glass 32, rod lens 35, sensor chip 36, printed circuit board (PCB) 38 and connector 39. During operation, the light source 30 would illuminate the target through the glass 32 first. Then, the reflected image of the target would be focused by the rod lens 35 and passed to the sensor chip 36 for sensing. Further, The sensor chip 36 can be mounted on the PCB 38, which is connected to the system via the connector 39. FIG. 2 shows a block diagram of commonly used CIS module according to the prior art.

Please refer to FIG. 3 of a simplified block diagram showing a CIS Scanner 50 using contact image-sensing module 52 according to the prior art. The CIS Scanner 50 includes at least one contact image sensor module (CIS) 52, a motor 54 operatively connected to and driving the CIS 52, a timing module 55 operatively connected to and inputting a start pulse 552 and a clock 554 to the CIS 52. As long as the CIS 52 has completed its own document reading session, the scanned image signal 57 and an end pulse 59 will be outputted.

Referring to FIG. 4 of another simplified block diagram illustrating another CIS Scanner 100 having two contact image sensors module 102 and 104. As well as the case of a single contact image sensor module shown in FIG. 3, contact image sensors module 102 and 104 each is driven by a motor 105, and a timing generator 106, which generates a start pulse #1 1061, a clock 1062 and a start pulse #2 1064, a clock 1062 to the CIS #1 102 and CIS #2 104, respectively. After corresponding document reading sessions are finished, CIS #1 102 and CIS #2 104 respectively sends a corresponding scanned image signals 113 and 115 to an multiple-channel analog-to-digital converter (A/D converter) 108. Still, the CIS #1 102 and CIS #2 104 all output end pulses 107 and 207, respectively, so as to indicate that corresponding document reading sessions are finished. Scanned image signals #1 and #2 from different contact image sensors 102 and 104 are analog-based as outputted, thus the multiple-channel A/D converter 108 is for converting these analog-based image signals into digitalized ones. Thereafter, a digitalized image processor (DIP) 111 takes over the whole process, and then outputs digitalized image signals through an appropriate interface to computers (not shown) for further processing or stores the digitalized image signals into memory 117. Therein, the memory 117 can be disposed in the computers or CIS Scanner 100. It appears that the timing generator 106 has to output different start pulses such as start pulses #1 and #2 to respective contact image sensors module 102 and 104, so as to trigger their own document reading sessions. To be more specific, the timing generator 106 is supposed to generate the start pulse #2 to CIS #2 after the end pulse #1 of the CIS #1 is outputted, leading to some sort of time delay because the timing generator 106 has to recognize the existence of the end pulse 107 (end pulse #1) outputted by the CIS #1, before having the start pulse #2 sent out to the CIS #2. FIG. 4 only depicts an embodiment of a contact image-sensing module with two contact image sensors, but, in practice, the number of contact image sensors in one contact image-sensing module varies case by case. In the case of two contact image sensors, the timing generator 106 in FIG. 4 has to generate two separate start pulses such as start pulses #1 and #2, in order to trigger operations of these two contact image sensors (CIS #1 and CIS #2) at different points.

When it comes to the two-sided document scanning, the prior art optical scanner with the contact image-sensing module 100 may include some other mechanical configurations such as inversion device (U.S. Pat. No. 6,563,611) to turn the original two-sided document around as one side thereof has been scanned. Thus, with the inversion device, this reference scanner module only requires one contact image sensor placed on one predetermined plane. As mentioned earlier, conventional scanning modules having two or more contact image sensors trigger these contact image sensors at different points by inputting different start pulses; in other words, even these contact image sensors of conventional scanning modules may have end pulses outputted, but these end pulses are not going to be used in triggering another contact image sensor. Furthermore, in many situations, only one contact image sensor will be employed, meaning the capability of scanning large size documents is undermined accordingly.

### SUMMARY OF THE INVENTION

It is therefore a primary objective of the present invention to provide a concatenated contact image sensor module having a plurality of contact image sensors each operatively connected to another in series, wherein the scanned image signals generated over the document reading sessions of contact image sensors are outputted sequentially, followed by the software integration of these scanned image signals, in order to enhance the capability of the optical scanner as dealing with large-sized documents. As for the two-sided document, the present invention optical scanner further includes two series of contact image sensors, wherein each series of contact image processors is horizontally disposed with respect to the other, and these two series of contact image sensors are triggered sequentially if necessary.

In accordance with the claimed invention, a method of operating a concatenated contact image-sensing module wherein the concatenated contact image-sensing module includes a plurality of contact image sensors (CIS) is provided. The present invention method includes providing a first contact image sensor for executing a first document reading session through the trigger of a start pulse and then outputting a corresponding first scanned image signal, providing a second contact image sensor operatively connected to the first contact image sensor for executing a second document reading session and then outputting a corresponding second scanned image signal, and providing a third contact image sensor operatively connected to the second contact image sensor for executing a third document reading session and then outputting a corresponding third scanned image signal. The first, the second and the third scanned image signals are outputted sequentially.

It is an advantage of the present invention that the end pulse of each contact image sensor is for triggering another contact image sensor, which is adjacently and operatively connected to the former contact image sensor, thereby, scanned image signals generated from all contact image sensors over periods of their document reading sessions are outputted sequentially. Still, in the case of not having the end pulse serve as another start pulse of another contact image sensor, the present invention further includes an analog switch having an internal counter therein, not only for receiving the scanned signals from these contact image sensors but also selecting and outputting these received scanned image signals in a sequential manner. A software will be further provided for integrating the sequentially outputted scanned image signals in the case of having a large-sized document scanned. As to the double-sided document scanning, the present invention optical scanner further provides two series of contact image sensors, one of which is disposed horizontally with respect to the other one and both of which are operated sequentially. Thus, the present invention optical scanner is able to deal with the large-sized document even it is in double-sided form.

These and other objectives of the present invention will no doubt become obvious to those of ordinary skill in the art after reading the following detailed description of the preferred embodiment illustrated in various figures and drawings.

### BRIEF DESCRIPTION OF THE DRAWINGS

FIG. 1 is a cross section view of a Contact Image Sensor module according to the prior art.

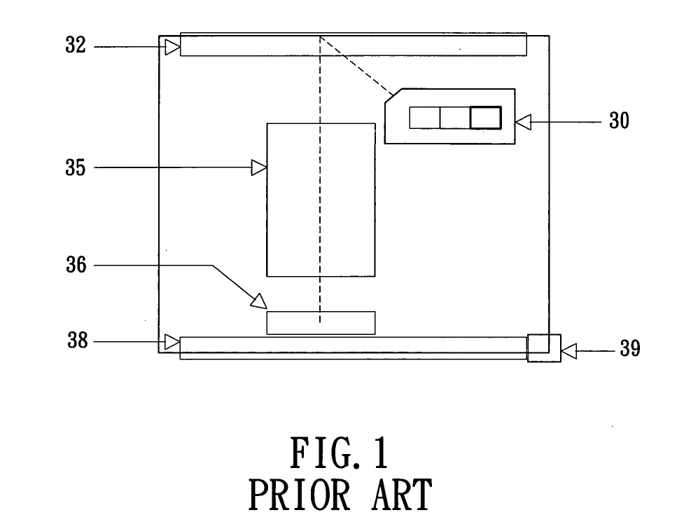

FIG. 2 is a block diagram of a commonly used Contact Image Sensor module according to the prior art.

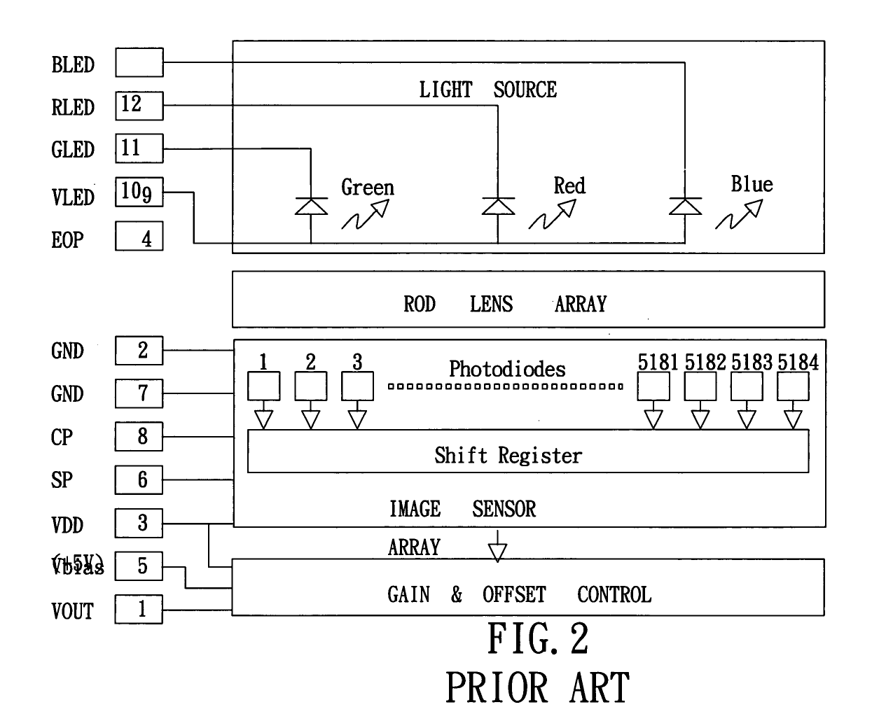

FIG. 3 is a simplified block diagram showing a Scanner with contact image-sensing module according to the prior art.

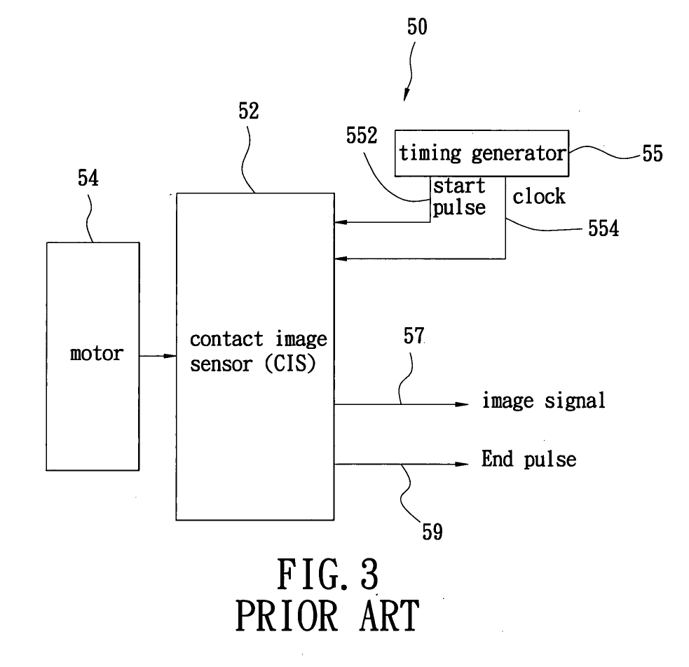

FIG. 4 is another simplified block diagram illustrating another Scanner having two contact image sensor modules.

FIG. 5 is a simplified block diagram of an optical scanner according to the present invention.

FIG. 6 is another simplified block diagram of another optical scanner embodiment based on the present invention.

FIG. 7A is a timing diagrams illustrating the output of scanned image signals of the optical scanners shown in FIG. 3.

FIG. 7B is a timing diagrams illustrating the output of scanned image signals of the optical scanners shown in FIG. 4.

### DETAILED DESCRIPTION OF THE PREFERRED EMBODIMENT

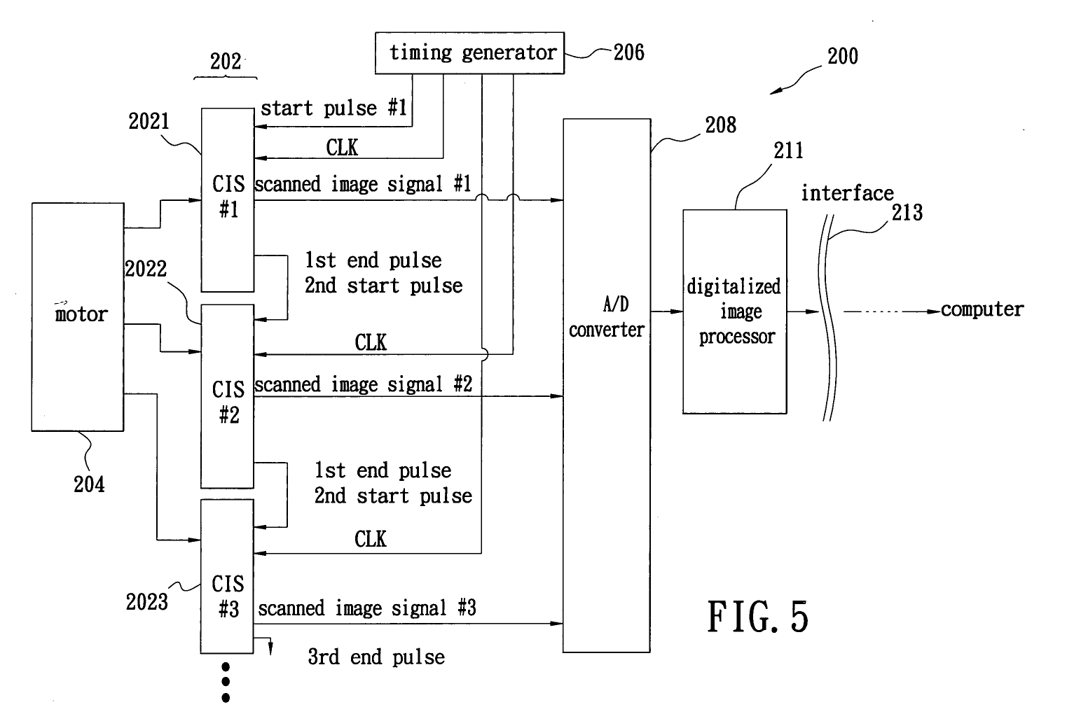

Please refer to FIG. 5 of a simplified block diagram of an optical scanner 200 according to the present invention. The optical scanner 200 includes a contact image-sensing module 202 having contact image sensors 2021, 2022 and 2023 operatively connected to another in series, a motor 204 for driving the contact image-sensing module 202 (i.e., these contact image sensors 2021, 2022 and 2023) and a timing generator 206. In this embodiment, only three contact image sensors 2021, 2022 and 2023 are illustrated in FIG. 5. However, in practice, the number of concatenated contact image sensors is not limit. As the optical scanner 200 is going to operate, the timing generator 206 first inputs a start pulse (“Start Pulse #1”) to the first (end) contact image sensor 2021 (“CIS #1”) to trigger a first document reading session for the corresponding part of the document. After the first document reading session is finished, a first scanned image signal (“Scanned Image Signal #1”) and a first end pulse (“1^{st} End Pulse”) are outputted, wherein the first scanned image signal is sent to an multiple-channel analog-to-digital converter (A/D converter) 208 as the first end pulse is outputted to another contact image sensor (i.e., second contact image sensor) to form a second start pulse (“2^{st} Start Pulse”) for triggering a second document reading session for the corresponding part of the document, while the size of the document prepared to be scanned is not the normal (standard) one like A4 or letter size. Preferably, each contact image sensor is responsible for a standard size document scanning, and with a number of the same contact image sensors operatively connected in series, the optical scanner 200 of this embodiment is able to deal with the large-size document scanning, as each part of the large-size document is outputted sequentially and then integrated together. The timing generator 206 further presents a clock (“CLK”) to every contact image sensor 2021, 2022 and 2023. As receiving the second start pulse, the second contact image sensor 2022 performs its own document reading session and outputs a second scanned image signal (“Scanned Image Signal #2”) to the multiple-channel A/D converter 208 as well, and meanwhile, another end pulse (second end pulse; “2^{nd} end pulse”) is outputted to form a third start pulse (“3^{st} Start Pulse”) to another contact image sensor 2023, which is operatively connected to the second contact image sensor 2022. Following a corresponding third document reading session is finished, a third scanned image signal (“Scanned Image Signal #3) is outputted to the multiple-channel A/D converter 208. Then, a third end pulse (“3^{nd} end pulse”) is outputted to next concatenated contact image sensor.

It appears that the multiple-channel A/D converter 208 receives these scanned image signals in a sequential manner, given these scanned image signals are outputted in the same sequential manner. Scanned image signals outputted from corresponding contact image sensors 2021, 2022 and 2023 are analog-based, and the multiple-channel A/D converter 208 is to convert these analog-based scanned image signals into their digitalized forms. Thereafter, these digitalized scanned image signals are then processed by a digitalized image processor 211 and then transferred through an interface 213, such as an USB-based one, to outside computers for further processing. The computer may include an image processing software, for integrating these scanned image signals outputted from the digitalized image processor 211. While the document is not of the normal standard size, the optical scanner 200 according to the present invention requires at least two document reading sessions, provided each contact image sensor is capable of dealing with the standard size (in terms of width) document, to output scanned image signals sequentially to the multiple-channel A/D converter 208. These sequentially outputted scanned image signals are also outputted to the digitalized image processor 211 in the same sequential manner. After the software integrating these two scanned image signals together, the final outcome of the scanning of the not-standard-size document will be generated.

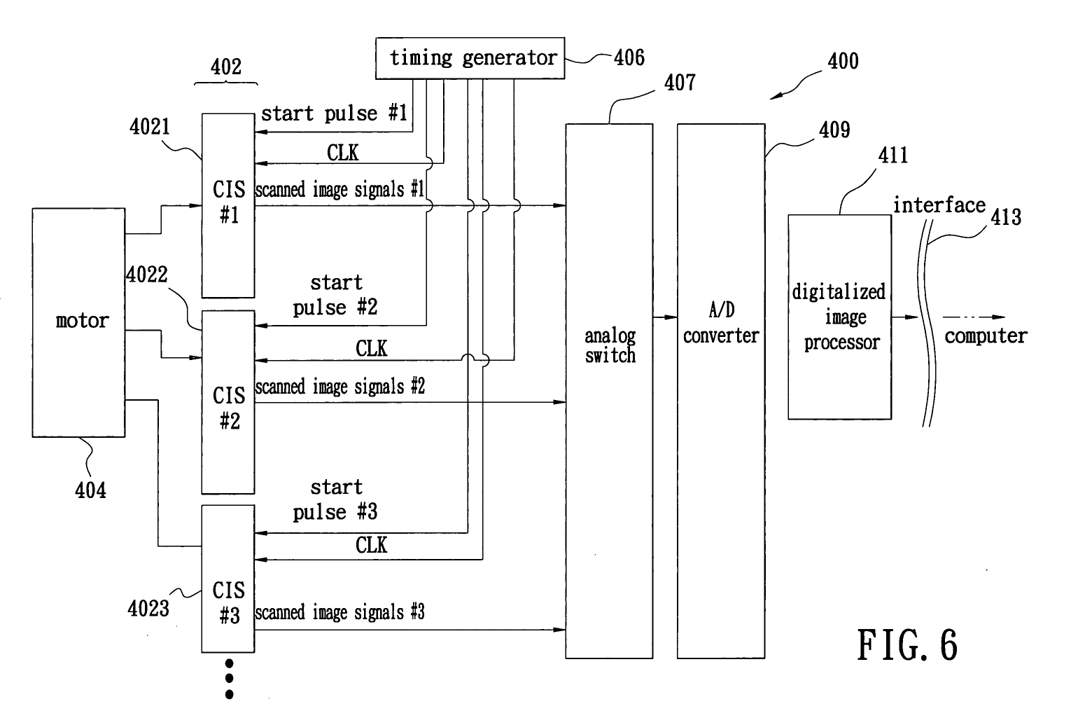

Please refer to FIG. 6 of another simplified block diagram of another optical scanner embodiment 400 based on the present invention. The optical scanner 400 includes a contact image-sensing module 402 having a plurality of contact image sensors 4021, 4022 and 4023 operatively connected to another in series, a motor 404 for driving the contact image-sensing module 402 (i.e., these contact image sensors 4021, 4022 and 4023) and a timing generator 406. Similarly, in this embodiment, only three contact image sensors 4021, 4022 and 4023 are illustrated in FIG. 6. However, in practice, the number of concatenated contact image sensors is not limit. As the optical scanner 400 is going to operate, the timing generator 406 first inputs a start pulse (“Start Pulse”) to a first (end) contact image sensor 4021 (“CIS #1”) to trigger a first document reading session for the corresponding part of the document. Then, a corresponding first scanned image signal (“Scanned Image Signal #1”) is outputted to an analog switch 407. After the first document reading session is finished, the timing generator further outputs a second start pulse (“Start Pulse #2”) to the second contact image sensor 4022, for the triggering of a second corresponding document reading session, and, after the second document reading session is finished, a corresponding second scanned image signal (“Scanned Image Signal #2”) is outputted to the analog switch 407 as well. The third contact image sensor 4023 is also operated with the input of a third start pulse (“Start Pulse #3”), and then a third scanned image signal (“Scanned Image Signal #3”) is outputted to the analog switch 407. It appears that these three scanned image signals, still analog-based so far, are inputted to the analog switch 407 sequentially. After receiving all these three scanned image signals, the analog switch 407 also outputs these three scanned image signals in a sequential manner.

The analog switch 407 further includes an internal counter (not shown) therein. The internal counter is for setting a predetermined period of time, and the analog switch 407 selects and outputs all these scanned image signals to an analog-to-digital converter (A/D converter) 409 in a sequential manner according to the setting of the predetermined period of time. To be more specific, the analog switch 407 is supposed to select and output the first scanned image signal, which is outputted to the analog switch 407 first, then to do so on the second and the third scanned image signals, in this order, once one predetermined period of time passes after the selection of the first and the second scanned image signals, respectively. No matter the scanned image signals are of the form of digitalized or analog-based, they are outputted from their corresponding contact image sensors 4021, 4022 and 4023 and the analog switch 407 sequentially. Even with the further processing provided from a digitalized image processor 411 and being transferred through a predetermined interface 413 (such as an USB-based interface) to computers, the output of these scanned image signals still remains as being in the sequential manner.

Preferably, each contact image sensor is responsible for a standard size document scanning, and with a number of the same contact image sensors operatively connected in series, the optical scanner 400 of this embodiment is able to deal with the large-size document scanning, as each part of the large-size document is outputted sequentially and then integrated together. Software stored within the computers performs the integration of scanned image signals. The timing generator 406 further presents a clock (“CLK”) to every contact image sensor 4021, 4022 and 4023.

Scanned image signals outputted from corresponding contact image sensors 4021, 4022 and 4023 are analog-based, and the A/D converter 409 is to convert these analog-based scanned image signals into their corresponding digitalized forms. It appears that the multiple-channel A/D converter 208 receives these scanned image signals in a sequential manner, given these scanned image signals are outputted by the analog switch 407 with a sequential selection. While the document is not of the normal standard size, the optical scanner 400 according to the present invention requires at least two document reading sessions, provided in this case each contact image sensor is capable of dealing with the standard size (in terms of width) document. After the software integrating these two scanned image signals together, the final outcome of the scanning of the not-standard-size document will be generated.

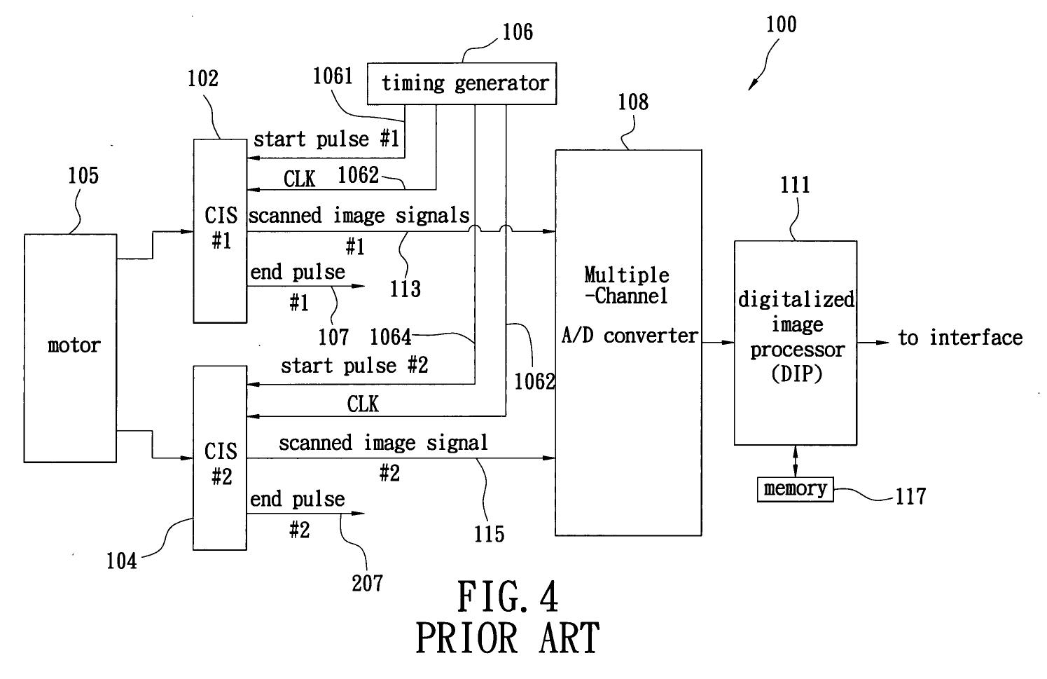

In another embodiment, the analog switch 407 illustrated in FIG. 4 can be omitted and the scanned image signals can be directly sent to the A/D converter 409 for digitalizing. After performing digitalization, the A/D converter 409 will store the digitalized image data into a memory (not shown in FIG. 6). Then, the digitalized image processor 411 can read the digitalized image data from the memory in the sequential manner.

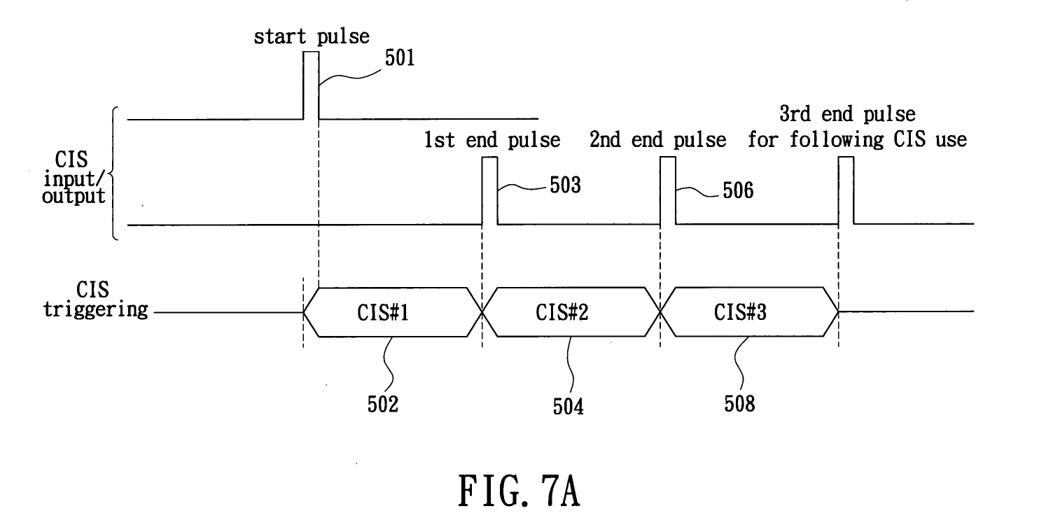

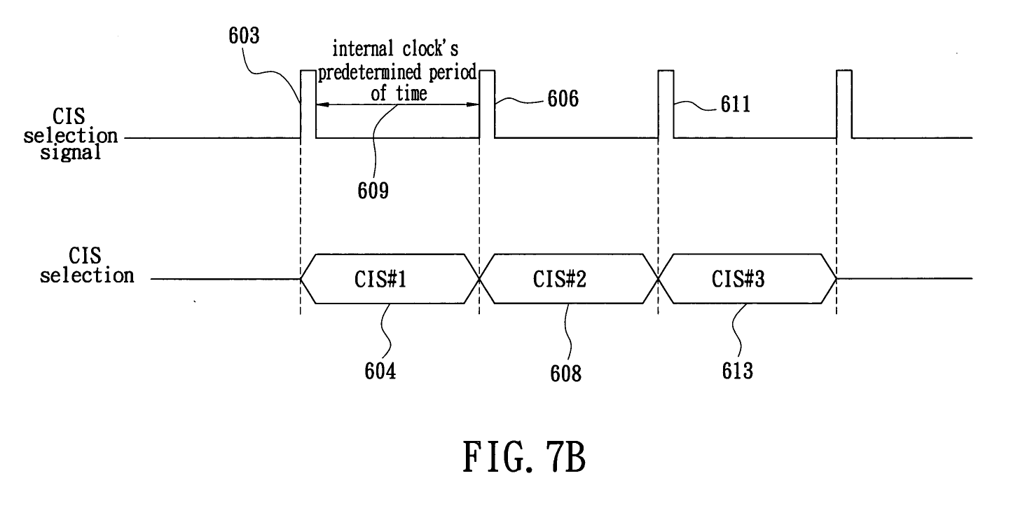

Please refer to FIGS. 7A and 7B of timing diagrams illustrating two ways of outputting scanned image signals of two optical scanners shown in FIGS. 5 and 6, respectively. In FIG. 7A, a start pulse 501 is generated from the aforementioned timing generator and inputted to an end contact image sensor (i.e., a first contact image sensor) to trigger a corresponding first document reading session 502; on the heels of the finishing of the first document reading session, the end contact image sensor generates a first end pulse 503 to a second contact image sensor, which is adjacently and operatively connected to the end (first) contact image sensor, for the triggering of the execution of a second document reading session 504. The same rule applies to the second document reading session 504. In the wake of the second document reading session is completed, a second end pulse 506 will be outputted from the second contact image sensor to a third contact image sensor adjacently and operatively connected to the second contact image sensor, wherein these three contact image sensors are operatively connected in series and consist of a contact image-sensing module, to trigger the third document reading session 508. There is no doubt that the number of contact image sensors varies case by case, thus, the finishing of the third document reading session 508 accompanies with the generation of another end pulse, such as a third end pulse. The third end pulse will be inputted to another contact image sensor for the purpose of triggering another corresponding document reading session, if necessary.

FIG. 7B shows the operation of the optical scanner in FIG. 6. Unlike its counterpart in FIG. 5, the optical scanner in FIG. 6 employs no use of end pulses. Start pulses generated from the timing generator are for triggering contact image sensors to perform their own document reading sessions and then output scanned image signals as these document reading sessions are finished. Outputted scanned image signals are transferred to analog switch, where these scanned image signals are selected and then outputted to A/D converters. Before having scanned image signals selected, A/D converter has received all necessary scanned image signals consisting of an entire document, regardless of its size. Therefore, while the first one selection signal 603 is generated, the first scanned image signal 604 will be selected to be outputted; another selection signal like 606 will be generated to select and output the second scanned image signal 608, after a predetermined period of time 609 (preferably, several pixel clocks) counting from the toggle of the first selection signal 603; thus, the scanned image signals are outputted sequentially, given another (the third) selection signal (pulse) 611 will be generated after another predetermined period of time counting the toggle of the second selection signal (pulse) 606, in order to select and output the third scanned image signals. In summary, whether with the analog switch or not, the optical scanner according to the present invention outputs scanned image signals sequentially in the cases of normal (standard) or large-sized document scanning. Even as dealing with the case of a double-sided document, the optical scanner of the present invention includes two contact image-sensing modules having a plurality of contact image sensors operatively connected in series, one of which is disposed horizontally with respect to the other one. Contact image-sensing modules operate sequentially, as contact image sensors thereof operate in a sequential manner as well. The aforementioned software may be able to integrate sequentially outputted scanned image signals, which are digitalized at the present stage, to generate a complete image of the original document.

In brief, the present invention discloses an operating method and an optical scanner employing this method. With at least two contact image sensors consisting of a contact image-sensing module, wherein these two contact image sensor are operatively connected in series, these contact image sensors of the optical scanner using the present operating method will output a corresponding portion of the entire image signal in a sequential manner, with the sequential triggering of the end pulses coming from the former contact image sensor which is in series connected with the operating (current) contact image sensor, or with the selection signal within the analog switch for selecting and outputting one of these scanned image signals. Thereafter, the software will be able to integrate these sequentially outputted scanned image signals together, in order to have an entire document.

In comparison with the prior art, the present invention takes advantage of end pulses generated from every contact image sensor after the corresponding document reading session is finished, wherein these end pulses serve as start pulses of other contact image sensors to trigger corresponding document reading sessions thereof. It appears that because contact image sensors are triggered at different points, scanned image signals are outputted sequentially, even in the case of having an analog switch employed. The analog switch further incorporates a predetermined period of time (predetermined pixel clocks) while selecting received scanned image signals, in order to continue to output these scanned image signals in the same sequential manner.

Those skilled in the art will readily observe that numerous modifications and alterations of the device may be made while retaining the teaching of the invention. Accordingly, the above disclosure should be construed as limited only by the metes and bounds of the appended claims.

1. A method of operating a concatenated contact image-sensing module Scanner wherein the concatenated contact image-sensing module Scanner includes a plurality of contact image sensors module (CIS), comprising:
providing a first contact image sensor module for executing a first document reading session through the trigger of a start pulse, and then the first contact image sensor module outputting a corresponding first scanned image signal;
providing a second contact image sensor module operatively connected to the first contact image sensor module for executing a second document reading session and then the second contact image sensor module outputting a corresponding second scanned image signal; and
providing a third contact image sensor module operatively connected to the second contact image sensor module for executing a third document reading session and then the third contact image sensor module outputting a corresponding third scanned image signal; wherein the first, the second and the third scanned image signals are selected to be outputted sequentially.

2. The method of claim 1, further comprising a step of providing a first end pulse and a second end pulse outputted from the first and the second contact image sensors module to the second and the third contact image sensor module, respectively, for triggering executions of the second and third document reading sessions.

3. The method of claim 1, further comprising a step of providing an analog switch for receiving the first, the second and the third scanned image signals, wherein the analog switch further includes an internal counter therein wherein the internal counter sets an predetermined period of time in order to have the analog switch to select and output one of the first, the second and the third scanned image signals in a sequential manner.

4. The method of claim 1, further comprising a step of providing a software for integrating the corresponding outputted image signals in correspondingly sequential document reading sessions together.

5. The method of claim 1, further comprising a step of providing a timing generator for providing the start pulse to the first contact image sensor module.

6. The method of claim 1, wherein the first and the second contact image sensor module further output a first end pulse and a second end pulse to the second and the third contact image sensor module, respectively, as the first and the second document reading sessions are finished, for triggering executions of the second and the third document reading sessions.

7. The method of claim 1, further comprising a step of placing a first series of contact image sensor module and a second series of contact image sensor module disposed horizontally with respect to the first series of contact image sensor module, wherein the first and the second series of contact image sensor module are operated sequentially.

8. An optical scanner comprising:
a concatenated contact image-sensing module having a plurality of contact image sensor modules each operatively connected to another in series; and
a timing generator for providing a start pulse into a first contact image sensor module to trigger a first document reading session thereof and output a first scanned image signal;
wherein the concatenated CIS Scanner further comprises a second and a third contact image sensor modules for performing a second and a third document reading sessions, respectively, once triggered and outputting a second and a third scanned image signals, wherein the first, the second and the third contact image sensors are triggered sequentially.

9. The optical scanner of claim 8, wherein the CIS Scanner further includes a first series of contact image sensor module and a second series of contact image sensor module disposed horizontally with respect to the first series of contact image sensor module, wherein the contact image sensor module of the first and the second series of contact image sensor module are operated sequentially.

10. The optical scanner of claim 8, wherein the first and the second series of contact image sensor module are operated sequentially.

11. The optical scanner of claim 8, further comprising at least one analog-to-digital converter for receiving the first, the second and the third scanned image signals outputted from the first, the second and third document reading sessions, respectively, and converting the first, the second and the third scanned image signals into corresponding digitalized forms.

12. The optical scanner of claim 11, further comprising a digitalized image processor operatively connected to the analog-to-digital converter for receiving the first, the second and the third scanned image signals in digitalized forms.

13. The optical scanner of claim 8, further comprising an analog switch operatively connected to the first, the second and the third and more contact image sensor modules, for receiving the first, the second and the third and more scanned image signals, and selecting and then outputting one of the first, the second and the third and more scanned image signals sequentially.

14. The optical scanner of claim 13, wherein the analog switch further includes an internal counter for setting a predetermined period of time, in order to select and then output one of the first, the second and the third and more scanned image signals sequentially with the predetermined period of time duration.

15. The optical scanner of claim 8, wherein the first and the second contact image sensor modules output a first and a second end pulses to the second and third contact image sensor modules, respectively, in order to trigger the second and the third and more contact image sensor modules sequentially.

16. The optical scanner of claim 8, further comprising at least one interface for interfacing the optical scanner with at least one computer.

17. The optical scanner of claim 8, wherein the interface is an USB-based interface.

18. The optical scanner of claim 8 further comprising: a
a light source of the concatenated contact image-sensing module.

19. The optical scanner of claim 18, wherein the light source is a colorful or monochromatic visible light.

20. The optical scanner of claim 18, wherein the light source is an invisible light.

21. The optical scanner of claim 20, wherein the invisible light is an infrared (IR) or ultraviolet (UV) light.

22. An optical scanner comprising:
a concatenated contact image-sensing module having a plurality of contact image sensor modules each operatively connected to another in series; and
a timing generator for providing a start pulse into an end contact image sensor module to trigger a corresponding document reading session thereof and output a corresponding scanned image signal, wherein the end contact image sensor module is located at one end of the series-connected contact image sensor modules;
wherein the end contact image sensor module outputs a first end pulse as a second start pulse to another contact image sensor module, which is adjacently operatively connected to the end contact image sensor module, for outputting another scanned image signal after the document reading session of the end contact image sensor module is finished.

23. The optical scanner of claim 22, wherein the contact image module scanner further includes a first series of contact image sensor module and a second series of contact image sensor module disposed horizontally with respect to the first series of contact image sensor module, wherein the contact image sensor module of the first and the second series of contact image sensor module are operated sequentially.

24. The optical scanner of claim 22, wherein the first and the second series of contact image sensor modules are operated sequentially.

25. The optical scanner of claim 22, further comprising at least one analog-to-digital converter for receiving the scanned image signals outputted from the corresponding contact image sensors and converting the scanned image signals into corresponding digitalized forms.

26. The optical scanner of claim 25, further comprising a digitalized image processor operatively connected to the analog-to-digital converter for receiving the scanned image signals in digitalized forms.

27. The optical scanner of claim 22, further comprising an analog switch operatively connected to the contact image sensors, for receiving the scanned image signals and selecting and then outputting one of the scanned image signals sequentially.

28. The optical scanner of claim 27, wherein the analog switch further includes an internal counter for setting a predetermined period of time, in order to select and then output one of the scanned image signals sequentially with the predetermined period of time duration.

29. The optical scanner of claim 22, wherein the contact image sensor modules each outputs a corresponding end pulse to the adjacently operatively connected image sensor module, in order to trigger the second and the third contact image sensor modules sequentially.

30. The optical scanner of claim 22, further comprising at least one interface for interfacing the optical scanner with at least one computer.

31. The optical scanner of claim 22, wherein the interface is an USB-based interface.

32. The optical scanner of claim 22 further comprising: a
a light source of the concatenated contact image-sensing module.

33. The optical scanner of claim 32, wherein the light source is a colorful or monochromatic visible light.

34. The optical scanner of claim 32, wherein the light source is an invisible light.

35. The optical scanner of claim 34, wherein the invisible light is an infrared (IR) or ultraviolet (UV) light.

36. An optical scanner comprising:
a concatenated contact image-sensing module having a plurality of contact image sensor modules each operatively connected to another in series; and
a timing generator for providing a start pulse into an end contact image sensor module to trigger a corresponding document reading session thereof and output a corresponding scanned image signal, wherein the end contact image sensor module is located at one end of the series-connected contact image sensor modules;
wherein a portion of these CIS modules is placed in a face-up manner and another portion is placed in a face-down manner; thereby, the optical scanner being capable of scanning a double sided document.
